(19) United States
(12) Patent Application Publication
(10) Pub. No.: US 2012/0076891 A1
(43) Pub. Date: Mar. 29, 2012

(54) STAGE 1 AND STAGE 2 INFANT FORMULA

(75) Inventors: John Sijben, Wageningen (NL); Günther Boehm, Leipzig (DE)

(73) Assignee: N.V. NUTRICIA

(21) Appl. No.: 13/260,139

(22) PCT Filed: Mar. 22, 2010
(86) PCT No.: PCT/NL10/50146

§ 371 Date: Dec. 12, 2011

(30) Foreign Application Priority Data
Mar. 24, 2009 (NL) PCT/NL2009/000068

(51) Int. Cl. A23C 9/152

(52) U.S. Cl. 426/2; 426/585

(57) ABSTRACT

The present invention concerns a kit of parts of infant milk formula comprising different amount of DHA for stimulating the development of brains.

### FIELD OF THE INVENTION

The present invention is in the field of infant formula. In particular the invention concerns an improved fat composition of infant formula which differentiates between the first stages of life of newborns. The present invention focuses on the composition of the LCPUFA content of infant formula during the first year of life

### BACKGROUND OF THE INVENTION

In humans, children who are breastfed have higher IQs than children not fed breast milk and this advantage persists into adulthood. In general there is experimental support for the hypothesis that that long-chain polyunsaturated fatty acids (LC-PUFAs) in breast milk enhance cognitive development. The most predominant LC-PUFAs present in human milk, but not in cow's milk are docosahexaenoic acid (DHA; C22:6n-3) and arachidonic acid (AA or ARA; C20:4n-6). Substantial amounts of DHA and AA accumulate in human brain during the first postnatal months and infants who are breastfed have higher concentrations of DHA and AA than infant fed unsupplemented formulas.

Consequently, the use of (LC-PUFAs) as substrate to stimulate brain development is widely accepted and several recommendations to include relevant fatty acids in infant milk formula (IMF) exist. These recommendations are characterized by two aspects. The first aspect is that there is a focus on the quantitatively most dominating fatty acids DHA (n-3 family) and AA (n-6 family.) The second aspect is that the recommendation for the first and second half year of life are the same. This is also reflected in EU-directive 2006/141/EC of 22 Dec. 2006. The latter is based on the observation that with increasing duration of breast feeding the percentage of LC-PUFAs of breast milk lipids decreases whereas the amount of precursor C-18 fatty acids increases.

US 2004/170668 discloses infant formula with a wide range of DHA and AA, in particular suited for enhancing growth of preterm infants.

WO 2008/108651 aims to provide a food or supplement which can make a favorable contribution to the development of the brains and the development and the cognitive skills of a child. The document differentiates in foods for infants of 0 to 6 months and from 6 to 12 months and for infants of over a year by applying different ratios of tryptophan:tyrosine in the respective foods. The lipid composition of the foods for the three groups is the same.

### SUMMARY OF THE INVENTION

The present invention is based on the new observation that in mothers eating western diet the amount of certain LC-PUFAs increases with the duration of lactation. It was found that this is particularly the case for the n-3 family, but within the n-6 family there is also an increase.

In order to offer infants that are not fed breast milk an optimal start in life the present inventors realized that the observed increase of LC-PUFA, especially with respect to the n-3 family, should be reflected in infant milk formula, contrary to the current practice where there is no differentiation in the amounts of LC-PUFAs in infant milk formula during the first year of life.

It is important that the variation in the LC-PUFA composition in breast milk is reflected in infant milk formula in order to optimally contribute to the development of tissue and organs for which LC-PUFAs in the diet are important. This is particularly the case for the development and functioning of the brains and eyes of newborns.

In the first 6 months of life, the brain of a newborn develops very rapidly. However, also in the period of 6 to 12 months, the brain of a newborn develops nearly as fast as in the first 6 months. Also the concentration of DHA in the brain of a newborn increases in the period of 6 to 12 months compared to the period of 0 to 6 months, see for Lauritzen et al.: The essentiality of long-chain n-3 fatty acids in relation to the development and function of the brain and retina in Prog. Lipid Res. 40: 1-94, 2001. Of the LC-PUFAs. DHA is predominantly present in the retina of the eye.

The varying need for DHA in the development vital functions such as the brain and the eyes that exists in the first year of life and that is met by the natural increase of LC-PUFA, in particular DHA in breast milk with the duration of lactation, should therefore also be delivered by infant milk formula.

Consequently the present invention concerns a combination of infant milk formula with at least one composition for the first half of the first year of life a newborn and another composition for the second half of the first year of life, wherein the amount of DHA in the composition for the second half of the first year of life of the newborn is increased compared to the composition for the first half year of life.

### DETAILED DESCRIPTION OF THE INVENTION

The present invention provides a method for providing nutrition to an infant comprising the steps of feeding an infant of less than 6 months a first infant milk formula comprising fat which comprises 0.2-0.4 wt % docosahexaenoic acid (DHA) based on total weight of fatty acids, and feeding an infant of more than 6 months a second infant milk formula comprising fat which comprises 0.3-0.6 wt % DHA based on total weight of fatty acids, wherein the amount of DHA in the second infant milk formula is 10-300% higher relative to the amount of DHA in the first infant milk formula.

In the context of the present invention, the method for providing nutrition to an infant is considered a non-therapeutic method.

In other words the invention concerns the use of fat comprising DHA for the manufacture of a first infant milk formula and a second infant milk formula, for providing nutrition to an infant, wherein said first infant milk formula is for providing nutrition to an infant of less than 6 months, said first infant milk formula comprising fat which comprises 0.2-0.4 wt % docosahexaenoic acid (DHA) based on total weight of fatty acids, and said second infant formula is for providing nutrition to an infant of more than 6 months, said second infant milk formula comprising fat which comprises 0.3-0.6 wt % DHA based on total weight of fatty acids, wherein the amount of DHA in said second infant milk formula is 10-300% higher relative to the amount of DHA in said first infant milk formula.

The present invention also concerns a kit of parts comprising
a a first infant milk formula comprising fat which comprises 0.2-0.4 wt % docosahexaenoic acid (DHA) based on total weight of fatty acids,
b a second infant milk formula comprising fat which comprises 0.3-0.6 wt % DHA based on total weight of fatty acids, and
   wherein the amount of DHA in the second infant milk formula is 10-300% higher relative to the amount of DHA in the first infant milk formula.

In one embodiment of the amount of DHA in the second infant milk formula is 50-150% higher relative to the amount of DHA in the first infant milk formula. This enables it to be even closer to the concentration difference determined in human milk.

In the breast milk of mothers eating western diet, also an increase in the total amount of n-3 LC-PUFAs has been observed with the duration of lactation. In the context of this invention LC-PUFAs are defined as the sum of C20 and C22 poly-unsaturated fatty acids.

Accordingly, in one embodiment of the invention, the second infant milk formula comprises 0.3-1.0 wt % n-3 LC-PUFAs based on total weight of fatty acids. In a preferred embodiment the amount of n-3 LC-PUFAs in the second infant milk formula is at least 0.02 wt. % higher relative to the amount of n-3 LC-PUFAs in the first infant milk formula. In a further preferred embodiment the amount of n-3 LC-PUFAs in the second infant milk formula is at least 0.04 wt. % higher relative to the amount of n-3 LC-PUFAs in the first infant milk formula.

Besides an increase in the amount of DHA, in the breast milk of mothers eating western diet also an increase in the amount of docosatetraenoic acid (DTA; C22:4n-6) has been observed with the duration of lactation.

Thus in one embodiment of the invention the second infant milk formula further comprises 0.001-0.15 wt % docosatetraenoic acid (DTA) based on total weight of fatty acids. In a preferred embodiment the amount of DTA in the second infant milk formula is at least 10-300% higher relative to the amount of DTA in the first infant milk formula. In a further preferred embodiment the amount of DTA in the second infant milk formula is at least 30-200% higher relative to the amount of DTA in the first infant milk formula. DTA is known to account for about 8% of the fatty acids of the brain, and hence providing a sufficient amount thereof is considered beneficial for the development of the brains of the newborn.

In contrast to the increased amounts of DHA and preferably the increased amounts of n-3 LC-PUFA and/or DTA in the second infant milk formula compared to the first infant milk formula, preferably the amount of total fat is higher in the first infant milk formula compared to the second infant milk formula. Thus in one embodiment of the invention the ratio of total fat per 100 ml in the first infant milk formula:total fat per 100 ml in the second infant milk formula is above 1. Preferably the ratio is above 1.05. Preferably the ratio does not exceed 1.30, preferably the ratio of total fat in the first infant milk formula:total fat in the second infant milk is below 1.25. It is noted that this ratio applies to the ready-to-drink formula, i.e. applies to the first and second infant milk formula that are administered according to the present method. With respect to the formula in powder form, the ratio of total fat in the first infant milk formula:total fat in the second infant milk may be higher, for example in the range of 1.1 to 1.5, preferably form 1.15 to 1.4.

The content of LC-PUFA in the first and second infant milk formula preferably does not exceed 3 wt. % of the total weight of fatty acids. Preferably the first and second infant milk formula comprise at least 0.1 wt. %, preferably at least 0.25 wt. %, more preferably at least 0.5 wt. %, even more preferably at least 0.75 wt. % LC-PUFAs of the total weight of fatty acids. The amount of n-3 (omega 3) LC-PUFA preferably is below 1 wt. % of the total weight of fatty acids. The amount of n-6 (omega 6) LC-PUFA preferably is below 2 wt. % of the total weight of fatty acids.

Besides DHA and preferably DTA, the first and second infant milk formula preferably comprise at least one LC-PUFA selected from the group consisting of eicosapentaenoic acid (EPA, 20:5 n3), arachidonic acid (AA, 20:4 n6) and docosapentaenoic acid (DPA, 22:5 n3), preferably eicosapentaenoic acid (EPA, 20:5 n3).

The LC-PUFA may be provided as free fatty acids, in triglyceride form, in diglyceride form, in monoglyceride form, in phospholipid form, or as a mixture of one of more of the above. In one embodiment the infant milk formula preferably comprise LC-PUFA in triglyceride form. A suitable source of LC-PUFAs is fish oil. In one embodiment the infant milk formula preferably comprise, preferably fish oil. In one embodiment the infant milk formula preferably comprises LC-PUFA in phospholipid form. In one embodiment the infant milk formula preferably comprise DHA in triglyceride and in phospholipid form. Providing the DHA in these two forms more closely mimics human milk. Also in one embodiment the infant milk formula preferably comprise DHA in phospholipid form. Suitable sources of phospholipids are buttermilk fat, soy lecithin and egg lipid. In particular egg lipid is a preferred source of phospholipids. Hence, the infant milk formula preferably comprise egg lipid, and in one embodiment the infant milk formula preferably comprise fish oil and egg lipid.

### Infant Formula

The infant milk formula in the present invention preferably contain 7.5 to 12.5 energy % protein; 40 to 55 energy % carbohydrates; and 35 to 50 energy % fat. The term energy %, also abbreviated as en %, represents the relative amount each constituent contributes to the total caloric value of the formula.

The present infant milk formula preferably comprise protein selected from the group consisting of non-human animal proteins (such as milk proteins, meat proteins and egg proteins), vegetable proteins (such as soy protein, wheat protein, rice protein, and pea protein) and amino acids and mixtures thereof. Preferably the infant milk formula comprise cow milk derived nitrogen source, particularly cow milk proteins such as casein and whey proteins. In one embodiment the infant milk formula comprises hydrolyzed milk protein, for example hydrolyzed casein and/or hydrolyzed whey protein.

Because lactose is a most important digestible carbohydrate source for infants, the present infant milk formula preferably comprise at least 35 wt. % lactose based on weight of total digestible carbohydrate, more preferably at least 50 wt. %, most preferably at least 75 wt. %.

The infant milk formula preferably have a caloric density between 0.1 and 2.5 kcal/ml, even more preferably a caloric density of between 0.5 and 1.5 kcal/ml, most preferably between 0.6 and 0.8 kcal/ml. The infant milk formula of the present invention preferably have an osmolality between 50 and 500 mOsm/kg, more preferably between 100 and 400 mOsm/kg.

When in liquid form, the infant milk formula preferably have a viscosity between 1 and 100 mPa·s, preferably between 1 and 60 mPa·s, more preferably between 1 and 20 mPa·s, most preferably between 1 and 10 mPa·s. The viscosity of the present liquid can be suitably determined using a Physica Rheometer MCR 300 (Physica Messtechnik GmbH, Ostfilden, Germany) at shear rate of 95 s⁻¹ at 20° C.

In one embodiment the infant milk formula are in powder form. In one embodiment the present invention concerns packaged powder infant milk formula, preferably accompanied with instructions to admix the powder with a suitable amount of liquid, preferably with water, thereby resulting in a liquid infant nutrition with a viscosity between 1 and 100 mPa·s. This viscosity closely resembles the viscosity of human milk. Furthermore, a low viscosity results in a normal gastric emptying and a better energy intake, which is essential for infants which need the energy for optimal growth and development.

### Use

At present, different infant milk formula are available that differentiate in the nutritional needs of infants during the first year of life. Such infant formula are commonly designated as stage 1 and stage 2 infant formula, the stage 1 infant formula being for infants in the first half year of life, and stage 2 being for infants of more than 6 months.

The present kit of parts is provided to optimally meet the needs of infants in terms of LC-PUFA composition during the first year of life and differentiates in infant formula for the first 6 months of the first year of life and for more than 6 months. Thus in one embodiment according to the invention, the first infant formula of the present kit of parts is for infants, or is for administration to infants, of less than 6 months and the second infant formula of the present kit of parts is for infants, or is for administration to infants, of 6 months and more. In one embodiment the second infant formula of the present kit of parts is for infants of 6-12 months. In particular the first infant formula of the present kit of parts is for the use to provide nutrition to an infant of less than 6 months and the second infant formula of the present kit of parts is for the use to provide nutrition to an infant of 6 months and more, preferably to provide nutrition to infants of 6-12 months.

In one embodiment, the infant formula, particularly of the present kit of parts, are for use for stimulating brain development and/or stimulating eye development. In one embodiment the invention is for use for stimulating brain development and/or stimulating eye development, preferably for stimulating brain development.

In other words the present inventions concerns the use of fat comprising DHA, for the manufacture of a kit of parts according to the present invention, in particular a kit of parts comprising a first infant milk formula and a second infant milk formula as defined herein, for stimulating brain development and/or stimulating eye development, preferably for stimulating brain development.

In general the present invention is for use to stimulate the development of cognitive skills of the infant. In the context of this invention the term ‘cognitive skills’ comprises a range of passive and active mental activities directed to taking in, processing, assessing, applying and (re)producing information, such as listening, reading, remembering, speaking, writing, seeing, understanding, judging and deciding

### EXAMPLES

### Example 1

A large birth cohort study was carried out in Germany. Women with a baby of <32 gestational weeks, a baby of <2500 g birth weight, or a baby transferred to inpatient paediatric care immediately after delivery were excluded. Overall, 1066 women were included into this study, of whom 462 (43.3%) still breast-fed both at the ages of 6 weeks and 6 months. The vast majority of the still breast-feeding mothers (around 98%) provided samples at the 6th month of lactation.

### Sample Collection

Both at the 6th week and the 6^{th} month of lactation, 10 ml human milk was collected, immediately cooled and frozen at −80° C. within 24 h.

### Analytical Methods

Fat contents were measured by the cremotocrit method. Fatty acid methyl esters were measured by high-resolution capillary gas-liquid chromatography with the use of a Finnigan 9001 chromatograph (Finnigan/Tremetrics Inc, Austin, Tex.) with split injection (1:15) and a flame ionization detector. A 60-m cyanopropyl column (DB-23; J&W Scientific, Folsom, Calif.) was used. Fatty acids with chain lengths between 10 and 24 carbon atoms were analyzed. Fatty acid values are presented in weight %, as medians with the range of first to third quartile.

### Statistical Analysis

For statistical analysis SAS STATISTICAL SOFTWARE (version 8, 1st ed; SAS Institute, Cary, N.C.) was used. The Kruskal-Wallis test and chi-square test were carried out for the difference between the groups. Wilcoxon's paired test was used to detect the difference between the fatty acid composition of human milk samples at the 6^{th} week and the 6^{th} month of lactation. Correlations between trans fatty acids and LC-PUFAs were calculated by partial Spearman's rho correlation coefficients, adjusting for nationality and place of birth. Results were considered as statistically significant at p<0.05.

### Results

Values are expressed as % weight/weight. Values of the n-3 essential fatty acid, alpha-linolenic acid (C18:3n-3, ALA) and the most important n-3 metabolite, DHA were significantly higher at the 6^{th} month than at the 6^{th} week of lactation. With the advancement of lactation, also significant increases in gamma-linolenic acid (C18:3n-6) was observed, as well as in the most important n-6 metabolite, AA and C22:4n-6. Also a significant increases in docosatetraenoic acid (C22:4n-6, DTA) was observed.

TABLE 1
Fatty acid composition of total lipids in milk of 462 lactating women
after 6 weeks and 6 months of lactation. (Values are given
as median with range from the first to the third quartile)

| Fatty acid | 6^{th} week | 6^{th} months | P* |
|---|---|---|---|
| C18:3n-6 | 0.12 (0.14) | 0.16 (0.11) | <0.001 |
| C20:4n-6 | 0.46 (0.32) | 0.48 (0.23) | <0.001 |
| C22:4n-6 | 0.06 (0.10) | 0.11 (0.07) | <0.001 |
| Sum of n-6 LCPUFA | 1.11 (0.72) | 1.19 (0.45) | <0.001 |
| C18:3n-3 | 0.69 (0.42) | 0.75 (0.41) | <0.001 |
| C22:6n-3 | 0.17 (0.23) | 0.23 (0.15) | <0.001 |
| Sum of n-3 LCPUFA | 0.36 (0.57) | 0.56 (0.34) | <0.001 |

*Wilcoxon's paired test

Paired statistical analysis showed high level of significance in fatty acids with minuscule differences between medians and with large interquartile ranges. This observation is in concert with the assumption of high degree of tracking of fatty acid profiles within the same mother. The major biological finding of this study is the significant increase of all LC-PUFA percentage values (with the exception of C20:3n-6) from the 6^{th} week to the 6^{th} month of lactation. It may be disputed whether some of the small differences seen (e.g. in AA values or in the sum of n-6 LC-PUFAs) are biologically relevant. Median DHA values and the sum of n-3 LC-PUFAs increased by about 35% and 55%, respectively.

The present data are in contrast with the general view that the percentage contribution of LC-PUFAs to human milk lipids decreases with increasing duration of breast-feeding.

It may thus be concluded that the LC-PUFA intake of the breast-fed infant remains stable throughout the period of exclusive breast-feeding, in spite of the obvious decrease of milk intake refereed to units of body weight.

### Example 2

### Fat Compositions

Fat blends were developed for term infants of less than 6 months of age and for infants of 6 months and older wherein the levels of AA, DHA and EPA are provided as detailed below. These levels are reached by proving approximately 95% standard vegetable oil that contain no or very low levels of LC-PUFA. The sources of the LC-PUFAs are indicated also.

### Example 2

| | For infants less | For infants 6 |
|---|---|---|
| | than 6 months | months and older |
| Total AA (% of total FA) | 0.2 | 0.2 |
| AA from egg lipid (%) | 12 | 12 |
| AA from single cell AA oil (%) | 82 | 81 |
| AA from fish oil (%) | 6 | 7 |
| Total DHA (% of total FA) | 0.2 | 0.25 |
| DHA from egg lipid (%) | 11 | 13 |
| DHA from tuna fish oil (%) | 89 | 87 |
| Total DTA (% of total FA) | 0.0013 | 0.0017 |
| Total EPA (% of total FA) | 0.04 | 0.06 |

### Example 3

| | For infants less | For infants 6 |
|---|---|---|
| | than 6 months | months and older |
| Total AA (% of total FA) | 0.35 | 0.35 |
| AA from egg lipid (%) | 12 | 12 |
| AA from single cell AA oil (%) | 84 | 82 |
| AA from fish oil (%) | 4 | 6 |
| Total DHA (% of total FA) | 0.2 | 0.25 |
| DHA from egg lipid (%) | 13 | 13 |
| DHA from tuna fish oil (%) | 87 | 87 |
| Total DTA (% of total FA) | 0.0024 | 0.0028 |
| Total EPA (% of total FA) | 0.04 | 0.06 |

### Example 4

| | For infants less | For infants 6 |
|---|---|---|
| | than 6 months | months and older |
| Total AA (% of total FA) | 0.35 | 0.35 |
| AA from egg lipid (%) | 12 | 12 |
| AA from single cell AA oil (%) | 82 | 82 |
| AA from fish oil (%) | 6 | 6 |
| Total DHA (% of total FA) | 0.35 | 0.45 |
| DHA from egg lipid (%) | 11 | 11 |
| DHA from tuna fish oil (%) | 89 | 89 |
| Total DTA (% of total FA) | 0.0024 | 0.0031 |
| Total EPA (% of total FA) | 0.08 | 0.1 |

### Example 5

| | For infants less | For infants 6 |
|---|---|---|
| | than 6 months | months and older |
| Total AA (% of total FA) | 0.2 | 0.2 |
| AA from single cell AA oil (%) | 95 | 94 |
| AA from fish oil (%) | 5 | 6 |
| Total DHA (% of total FA) | 0.2 | 0.25 |
| DHA from tuna fish oil (%) | 100 | 100 |
| Total EPA (% of total FA) | 0.05 | 0.06 |

### Example 6

| | For infants less | For infants 6 |
|---|---|---|
| | than 6 months | months and older |
| Total AA (% of total FA) | 0.35 | 0.35 |
| AA from single cell AA oil (%) | 96 | 95 |
| AA from fish oil (%) | 4 | 5 |
| Total DHA (% of total FA) | 0.2 | 0.25 |
| DHA from tuna fish oil (%) | 100 | 100 |
| Total EPA (% of total FA) | 0.05 | 0.06 |

### Example 7

| | For infants less | For infants older |
|---|---|---|
| | than 6 months | than 6 months |
| Total AA (% of total FA) | 0.35 | 0.35 |
| AA from single cell AA oil (%) | 95 | 94 |
| AA from fish oil (%) | 5 | 6 |
| Total DHA (% of total FA) | 0.35 | 0.45 |
| DHA from tuna fish oil | 100 | 100 |
| Total EPA (% of total FA) | 0.08 | 0.1 |

### Example 8

### Kit of Parts

Combination of a stage 1 and a stage 2 infant formula.

The stage 1 infant formula comprises powder comprising per 100 g powder:
Energy: 481 kcal
Protein: 9.6 g (comprising 3.8 g casein; 5.8 g whey)
Digestible Carbohydrates: 53.3 g (comprising 50.9 g lactose)
Fat: 25.5 g (comprising 11.0 g saturated fatty acids, 10.1 mono-unsaturated fatty acids, 4.4 g poly-unsaturated fatty acids comprising the LC-PUFAs as indicated in the fat blends for infants less than 6 months of examples 2-7)

The powder further comprises L-carnitine, choline, myo-inositol, taurine and nucleotides and minerals and trace elements and vitamins in amounts in compliance with the international guidelines for infant milk formula.

Instructions are provided to admix the powder with water, to yield a liquid product comprising per 100 ml:

Energy: 66 kcal

### Protein: 8 en %

1.3 g (comprising 0.5 g casein; 0.8 g whey)

### Digestible Carbohydrates: 44 en %

7.3 g (comprising 7.0 g lactose)

### Fat: 48 en %

3.5 g (comprising 1.5 g saturated fatty acids, 1.4 g mono-unsaturated fatty acids, 0.6 g poly-unsaturated fatty acids comprising the LC-PUFAs as indicated in the fat blends for infants less than 6 months of examples 2-7)
   Osmolarity: 300 mOsmol/l

The stage 2 infant formula comprises powder comprising per 100 g powder:
Energy: 463 kcal
Protein: 9.3 g (comprising 4.6 g casein; 4.6 g whey)
Digestible Carbohydrates: 58.2 g (comprising 40.9 g lactose)
Fat: 21.5 g (comprising 9.3 g saturated fatty acids, 8.6 mono-unsaturated fatty acids, 3.6 g poly-unsaturated fatty acids comprising the LC-PUFAs as indicated in the fat blends for infants less 6 months and older of examples 2-7)

The powder further comprises L-carnitine, choline, inositol, taurine and nucleotides and minerals and trace elements and vitamins in amounts in compliance with the international guidelines for infant milk formula.

Instructions are provided to admix the powder with water, to yield a liquid product comprising per 100 ml:

Energy: 68 kcal

### Protein: 8 en %

1.4 g (comprising 0.7 g casein; 0.7 g whey)

### Digestible Carbohydrates: 50 en %

8.6 g (comprising 6.0 g lactose)

### Fat: 42 en %

3.2 g (comprising 1.4 g saturated fatty acids, 1.3 g mono-unsaturated fatty acids, 0.5 g poly-unsaturated fatty acids comprising the LC-PUFAs as indicated in the fat blends for infants less than 6 months of examples 2-7)
   Osmolarity: 290 mOsmol/l.

1-14. (canceled)

15. A method for providing nutrition to an infant comprising:
(a) feeding an infant of less than 6 months of age a first infant milk formula comprising 0.2-0.4 wt % docosahexaenoic acid (DHA; C22:6n-3) based on total weight of fatty acids; and
(b) feeding the infant at more than 6 months of age a second infant milk formula comprising 0.3-0.6 wt % DHA based on total weight of fatty acids, wherein the amount of DHA in the second infant milk formula is 10-300% higher relative to the amount of DHA in the first infant milk formula.

16. The method according to claim 15, wherein the first and/or second infant milk formula comprise protein selected from the group consisting of non-human-animal proteins, vegetable proteins and amino acids or mixtures thereof.

17. The method according to claim 15, wherein the amount of DHA in the second infant milk formula is 50-150% higher relative to the amount of DHA in the first infant milk formula.

18. The method according to claim 15, wherein the second infant milk formula further comprises 0.001-0.15 wt % docosatetraenoic acid (DTA; C22:4n-6) based on total weight of fatty acids.

19. The method according to claim 18, wherein the amount of DTA in the second infant milk formula is at least 30-200% higher relative to the amount of DTA in the first infant milk formula.

20. The method according to claim 19, wherein the ratio of total fat per 100 ml in the first infant milk formula:total fat per 100 ml in the second infant milk formula is above 1.

21. The method according to claim 21, wherein the fat in the first and second infant milk formula comprises egg lipid.

22. A kit comprising
a. a first infant milk formula comprising 0.2-0.4 wt % docosahexaenoic acid (DHA; C22:6n-3) based on total weight of fatty acids, and
b. a second infant milk formula comprising 0.3-0.6 wt % DHA based on total weight of fatty acids,
wherein the amount of DHA in the second infant milk formula is 10-300% higher relative to the amount of DHA in the first infant milk formula, and
wherein the ratio of total fat per 100 ml in the first infant milk formula:total fat per 100 ml in the second infant milk formula is above 1.

23. The kit according to claim 22, wherein the amount of DHA in the second infant milk formula is 50-150% higher relative to the amount of DHA in the first infant milk formula.

24. The kit according to claim 22, wherein the second infant milk formula further comprises 0.001-0.15 wt % docosatetraenoic acid (DTA; C22:4n-6) based on total weight of fatty acids.

25. The kit according to claim 24, wherein the amount of DTA in the second infant milk formula is at least 10-300% higher relative to the amount of DTA in said first infant milk formula.

26. The kit according to claim 22, wherein the second infant milk formula comprises 0.3-1.0 wt % n-3 long-chain polyunsaturated fatty acids (LC-PUFAs) based on total weight of fatty acids, and wherein the amount of n-3 LC-PUFAs in the second infant milk formula is at least 0.03 wt. % higher relative to the amount of n-3 LC-PUFAs in the first infant milk formula.

27. The kit according to claim 22, wherein the fat in the first and second infant milk formula comprises phospholipids.

28. The kit according to claim 22, wherein the fat in the first and second infant milk formula comprises egg lipid.
